(19) United States
(12) Patent Application Publication
(10) Pub. No.: US 2025/0379279 A1
(43) Pub. Date: Dec. 11, 2025

(54) THERMAL MANAGEMENT IN BATTERY CELL ARRANGEMENTS

(71) Applicant: Valcon Labs, Inc., Milpitas, CA (US)

(72) Inventors: Bernd Ullmann, Pfinztal (DE); Jacob Matly, Milpitas, CA (US)

(21) Appl. No.: 18/876,182

(22) PCT Filed: Jun. 16, 2023
(86) PCT No.: PCT/US2023/025606

§ 371 Date: Dec. 17, 2024

Related U.S. Application Data
(60) Provisional application No. 63/353,574, filed on Jun. 18, 2022.

(51) Int. Cl. H01M 10/653; H01M 10/0525; H01M 10/625; H01M 10/659

(52) U.S. Cl. CPC H01M 10/653; H01M 10/0525; H01M 10/625; H01M 10/659; H01M 2220/20

(57) ABSTRACT

A battery unit comprises an arrangement of a plurality of discrete, stacked battery cells that implement one or more thermal management techniques. The arrangement of the stacked battery cells generates sufficient cooling within the battery unit during operation of the battery such that external cooling mechanisms are not implemented. In addition, the battery unit can comprise thermal management component that includes one or more materials to transfer heat away from the battery unit and/or one or more materials for storing and releasing heat that is produced during the operation of the battery.

### PRIORITY CLAIM

This application claims priority to U.S. Provisional Patent Application No. 63/353,574 filed Jun. 18, 2023, entitled THERMAL MANAGEMENT IN BATTERY CELL ARRANGEMENTS, which is incorporated by reference herein in its entirety.

### BACKGROUND

Lithium-ion batteries are used in a variety of applications from smart phones to laptop computers to vehicles. Although lithium-ion batteries operate through the reversible reduction of lithium ions to store and release energy, the designs of lithium-ion batteries can vary based on the different end-uses for the lithium-ion batteries. In addition, safety is often a consideration in the design of lithium-ion batteries. In many cases, the safety concerns related to lithium-ion batteries are addressed differently depending on the environment in which the lithium-ion batteries are operating. As a result, the safety features and battery designs implemented for lithium-ion batteries that operate in a smart phone can be different from the safety features and battery designs implemented for lithium-ion batteries used in cars and trucks.

### BRIEF DESCRIPTION OF THE DRAWINGS

FIG. 1 illustrates an example battery unit comprised of a number of battery cells arranged to transfer heat in a number of directions, in accordance with one or more example implementations.

FIG. 2 illustrates a number of example arrangements of materials of a heat transfer component coupled to one or more battery cells of a battery unit, in accordance with one or more example implementations.

### DETAILED DESCRIPTION

Existing solutions for thermal heat management in battery cells used to power features of vehicles rely mostly on external sources and equipment, such as coolers, heat exchangers, liquid-cooled chassis, cold plates, cooling pumps, liquid-filled enclosures and the like. These technologies, however, have disadvantages, including adding weight and cost to the vehicles housing the battery cells. This makes their use in various applications, such as urban air mobility (UAM) vehicles, limited. Implementations described herein are directed to thermal management of battery cell arrangements that forgo the need for external cooling or additional thermal management control equipment, while retaining the ability to produce cooling sufficient to mitigate overheating within the battery cell unit. The implementations described herein provide a non-flammable ceramic battery chemistry and implement thermal management techniques and battery designs that generate sufficient cooling such that external coolant is not used, and air cooling is sufficient in UAM vehicles driven by high power-density propulsion motors.

In one or more implementations, a lithium-ion battery unit comprises a number of battery cells. The battery cells include a number of layers with individual layers comprising a number of substrates and sublayers. In various examples, the layers of the battery cells are individually stacked, discrete layers. Thus, the layers of the battery cells in implementations described herein do not comprise various sheets of material that are wound in a tortious path. In addition, the layers of the battery cells include a solid oxide ceramic separator sublayer and a composite cathode-solid electrolyte sublayer. In one or more examples, the dimensions of the layers of the battery cells including the length, width, and height are configured to maximize the transfer of heat produced by the battery cell during operation to the environment. Additionally, implementations described herein include a thermal management component that is disposed adjacent to and/or around the battery cells. The thermal management component is configured to transfer a portion of the heat produced during operation of the battery cell to the environment and to store an additional portion of the heat produced during operation of the battery cell.

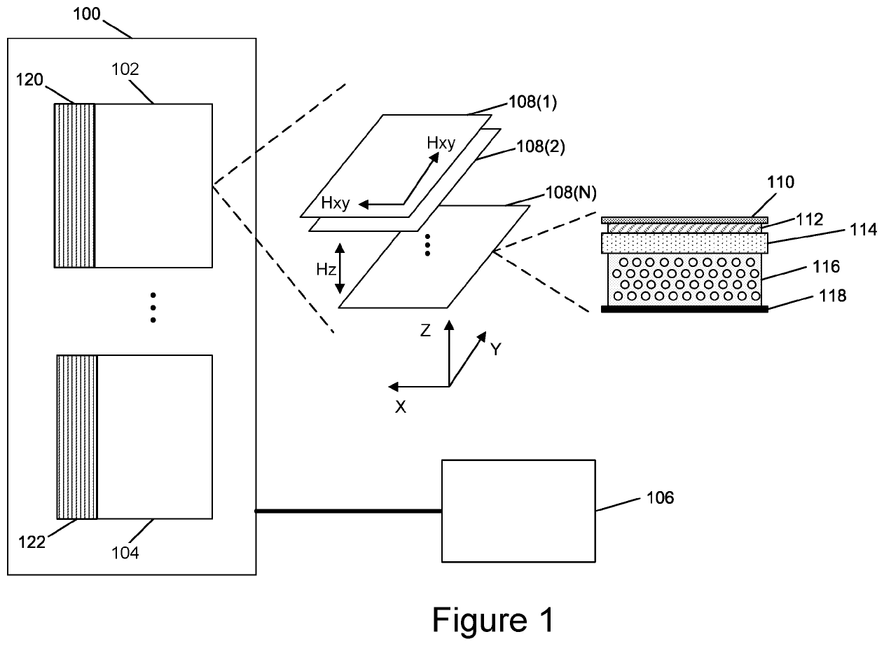

FIG. 1 illustrates an example battery unit 100 comprised of a number of battery cells arranged to transfer heat in a number of directions, in accordance with one or more example implementations. For example, the battery unit 100 includes a first a battery cell 102 up to an Nth battery cell 104. In one or more examples, the battery unit 100 can include from 2 battery cells to 200 battery cells, from 10 battery cells to 100 battery cells, from 50 battery cells to 150 battery cells, from 75 battery cells to 125 battery cells, from 100 battery cells to 200 battery cells, or from 150 battery cells to 200 battery cells. The battery cells of the battery unit 100 can comprise lithium-ion battery cells. In one or more illustrative examples, the battery cells of the battery unit 100 can comprise solid electrolyte battery cells.

The battery unit 100 can be coupled to a load 106. In various examples, the load 106 can include an engine, a propulsion system, or a powertrain of a vehicle. In one or more illustrative examples, the vehicle can include an electrified vehicle. In one or more additional illustrative examples, the vehicle can include an urban air mobility (UAM) vehicle. The battery cells of the battery unit 100 can be electrically coupled. To illustrate, the battery cells of the battery unit 100 can be coupled via a number of electrical connectors in series arrangements, in parallel arrangements, or a combination thereof.

In one or more examples, the battery cells 102, 104 can include a plurality of discrete layers. In various examples, the battery cells 102, 104 can individually include at least 2 layers, at least 5 layers, at least 10 layers, at least 25 layers, at least 50 layers, at least 75 layers, at least 100 layers, at least 125 layers, at least 150 layers, at least 175 layers, at least 200 layers, at least 250 layers, at least 300 layers, at least 350 layers, at least 400 layers, at least 450 layers, or at least 500 layers. In one or more illustrative examples, the battery cells 102, 104 can individually include from 1 layer to 500 layers, from 5 layers to 400 layers, from 50 layers to 150 layers, from 150 layers to 300 layers, from 200 layers to 300 layers, from 250 layers to 400 layers, or from 300 layers to 500 layers. In the illustrative example of FIG. 1, the battery unit 100 can include a first layer 108(1), a second layer 108(2), up to an Nth layer 108(N).

The individual layers 108 of the battery cell 102 can have dimensions in an x-direction, a y-direction, and a z-direction. In various examples, the individual layers can have values of dimensions in the x-direction and the y-direction that are at least 20 mm, at least 30 mm, at least 40 mm, at least 50 mm, at least 60 mm, at least 70 mm, at least 80 mm, at least 90 mm, or at least 100 mm. In one or more examples, the individual layers 108 can have values of dimensions in the x-direction and the y-direction from about 20 mm to about 100 mm, from about 30 mm to about 80 mm, or from about 50 mm to about 70 mm. In one or more illustrative examples, the individual layers 108 can have values of dimensions in the y direction that are no greater than 0.5 times the values of the individual layers 108 in the x-direction, no greater than 0.6 times the values of the individual layers 108 in the x-direction, no greater than 0.7 times the values of the individual layers 108 in the x-direction, no greater than 0.8 times the values of the individual layers 108 in the x-direction, or no greater than 0.9 times the values of the individual layers 108 in the x-direction. In one or more additional examples, the stacked layers 108 of the battery cell 102 can have a total height in the z-direction from about 20 mm to 100 mm, from about 30 mm to about 80 mm, or from about 50 mm to about 70 mm. In at least some examples, the dimensions of the stacked layers 108 of the battery cell 102 can have a substantially cubic shape. For example, the dimensions of the stacked layers 108 of the battery cell 102 can have values of dimensions in the x-direction, the y-direction, and the z-direction that are within about 20% of one another, within about 15% of one another, within about 10% of one another, within about 8% of one another, within about 5% of one another, within about 3% of one another, or within about 1% of one another.

Individual layers 108 of the battery cell 102 can include a number of substrates or sublayers. In one or more examples, the layers 108 of the battery cell 102 can individually include a first conductive substrate 110. In one or more the first conductive substrate 110 can comprise one or more metallic materials. In at least some examples, the first conductive substrate 110 can comprise copper, one or more alloys of copper, aluminum, one or more alloys of aluminum, or one or more combinations thereof. In at least some examples, the first conductive substrate 110 can be configured as a current collector. In one or more illustrative examples, the first conductive substrate 110 can have values of dimensions in the z-direction from about 2 micrometers (μm) to about 20 μm, from about 4 μm to about 16 μm, from about 8 μm to about 12 μm, from about 2 μm to about 10 μm, or from about 10 μm to about 20 μm.

In addition, the layers 108 of the battery cell 102 can individually include an anode substrate 112. In one or more examples, the anode substrate 112 can include a lithium-containing substrate. For example, the anode substrate 112 can comprise a lithium foil disposed on a copper current collector substrate 110. In at least some examples, the anode substrate 112 can be laminated on the first conductive substrate 110. In various examples, the anode substrate 112 can be deposited on the first conductive substrate 110 using an electrochemical plating process. In one or more illustrative examples, the anode substrate 112 can be deposited on the first conductive substrate 110 using a physical vapor deposition process. In one or more additional illustrative examples, the anode substrate 112 can have values of dimensions in the z-direction from about 5 μm to about 40 μm, from about 10 μm to about 30 μm, from about 15 μm to about 25 μm, from about 20 μm to about 30 μm, or from about 10 μm to about 20 μm.

Further, the layers 108 of the battery cell 102 can individually include a separator sublayer 114. The separator sublayer 114 can include one or more solid oxide ceramic materials. In one or more illustrative examples, the separator sublayer 114 can have an ionic conductivity from about 0.2 milliSiemens/centimeter (cm) to about 0.4 milliSiemens/cm at 25° C. In one or more additional illustrative examples, the separator sublayer 114 can be comprised one or more materials comprising Li₇La₃Zr₂O₁₂ (LLZO). In one or more further illustrative examples, the separator sublayer 114 can be comprised of LLZO doped with aluminum. In various examples, the separator sublayer 114 can be disposed in the layers 108 using a tape casting procedure. In at least some examples, the separator sublayer 114 can undergo one or more sintering processes after the tape casting process. The separator sublayer 114 can have values of dimensions in the z-direction, such as a height, from about 5 μm to about 40 μm, from about 10 μm to about 30 μm, from about 15 μm to about 25 μm, from about 20 μm to about 30 μm, or from about 10 μm to about 20 μm.

The layers 108 of the battery cell 102 can also individually include a composite cathode-electrolyte sublayer 116. The composite cathode-electrolyte sublayer 116 can include a solid electrolyte. In one or more examples, the composite cathode-electrolyte sublayer 116 can include a solid electrolyte comprising one or more sulfide materials. In various examples, the composite cathode-electrolyte sublayer 116 can include a solid electrolyte having an ionic conductivity from about 2 milliSiemens/cm to about 8 milliSiemens/cm at 25° C. In one or more illustrative examples, the composite cathode-electrolyte sublayer 116 can comprise Li₆PS₅X, where X=Cl or Br. In at least some examples, the composite cathode-electrolyte sublayer 116 can comprise a solid electrolyte having particles with diameters from about 1 μm to about 12 μm.

Additionally, the composite cathode-electrolyte sublayer 116 can include a cathode active material having a specific capacity of at least 200 milliamperes (mAh)/g. In one or more illustrative examples, the composite cathode-electrolyte sublayer 116 can include a cathode active material comprising nickel, cobalt, manganese, and lithium. In at least some examples, the composite cathode-electrolyte sublayer 116 can include a cathode active material comprising a NCM material, such as NCM 811. In various examples, the composite cathode-electrolyte layer 116 can include a cathode active material having an oxide coating. In one or more illustrative examples, the composite cathode-electrolyte sublayer 116 can include a cathode active material having particles with diameters from about 1 μm to about 12 μm.

Further, the composite cathode-electrolyte sublayer 116 can include one or more additional materials, such as one or more binders and/or one or more conductive additives. In various examples, the composite cathode-electrolyte sublayer 116 can include conductive additives that comprise carbon. In one or more examples, the composite cathode-electrolyte sublayer 116 can have a porosity from about 1% by volume to about 20% by volume, from about 2% by volume to about 10% by volume, or from about 3% by volume to about 6% by volume. In addition, the composite cathode-electrolyte sublayer 116 can have from about 80% by weight to about 90% by weight of cathode active material and from about 5% by weight to about 15% by weight cathode active material. In still other examples, the composite cathode-electrolyte sublayer 116 can have from about 1% by weight to about 3% by weight of one or more binders and/or from about 1% by weight to about 3% by weight of one or more conductive additives.

In one or more illustrative examples, the composite cathode-electrolyte sublayer 116 can have values of dimensions in the z-direction, such as a height, from about 100 μm to about 200 μm, from about 120 μm to about 180 μm, or from about 140 μm to about 160 μm.

Additionally, the layers 108 of the battery cell 102 can individually include a second conductive substrate 118. The second conductive substrate 118 can comprise one or more metallic materials. In at least some examples, the second conductive substrate 118 can comprise copper, one or more alloys of copper, aluminum, one or more alloys of aluminum, or one or more combinations thereof. In at least some examples, the second conductive substrate 118 can be configured as a current collector. In one or more illustrative examples, the second conductive substrate 110 can have values of dimensions in the z-direction from about 4 micrometers (μm) to about 30 μm, from about 8 μm to about 25 μm, from about 10 μm to about 20 μm, from about 20 μm to about 30 μm, or from about 15 μm to about 25 μm. In various examples, the composite cathode-electrolyte sublayer 116 can be applied to the second conductive substrate 118 as a slurry or as a paste using at least one of tape casting, extrusion, or screen-printing techniques.

In one or more examples, the battery cells 102, 104 of the battery unit 100 can individually have a gravimetric energy density of at least 100 watt hours/kilogram (kg), at least 150 watt hours/kg, at least 200 watt hours/kg, at least 250 watt hours/kg, at least 300 watt hours/kg, at least 350 watt hours/kg, at least 400 watt hours/kg, at least 450 watt hours/kg, at least 500 watt hours/kg, at least 550 watt hours/kg, or at least 600 watt hours/kg. Additionally, the battery cells 102, 104 of the battery unit 100 can individually have a mean discharge potential of at least 2.5 volts, at least 2.75 volts, at least 3 volts, at least 3.25 volts, at least 3.5 volts, at least 3.75 volts, or at least 4 volts. Further, the battery cells 102, 104 of the battery unit 100 can individually have an energy capacity of at least 75 ampere hours, at least 100 ampere hours, at least 125 ampere hours, at least 150 ampere hours, at least 175 ampere hours, at least 200 ampere hours, at least 225 ampere hours, or at least 250 ampere hours.

In one or more examples, the materials and the shape of the battery cells 102, 104 combine to enable heat transfer in the x-direction and in the y-direction indicate by Hxy in FIG. 1 as well as heat transfer in the z-direction indicated by Hz in FIG. 1. In one or more illustrative examples, the ratio of Hxy/Hz is at least 2, at least 3, at least 4, at least 5, at least 8, at least 10, or more. In various examples, having heat transfer in the xy direction greater than heat transfer in the z direction increases the total heat transfer out of the battery cells 102, 104. In one or more additional examples, the ratio between the height of the stack of layers 108 and the mean value of the dimensions of the layers 108 in the x-direction and the y-direction corresponds to the heat transfer rate.

The battery unit 100 can also include thermal management components coupled to the battery cells 102, 104. For example, a thermal management component 120 can be coupled to the first battery cell 102 and an additional thermal management component 122 can be coupled to the Nth battery cell 104. In various examples, the thermal management component 120 can encase the first battery cell 102 and the additional thermal management component 120 can encase the Nth battery cell 104. In various examples, the thermal management components 120, 122 can include one or more first materials to transfer heat produced by the respective battery cells 102, 104 away from the battery cells 102, 104. The thermal management components 120, 122 can also include one or more second materials to store and release heat produced by the respective battery cells 102, 104. In at least some examples, at least a portion of the thermal management components 120, 122 can be disposed between the battery cells of the battery unit 100.

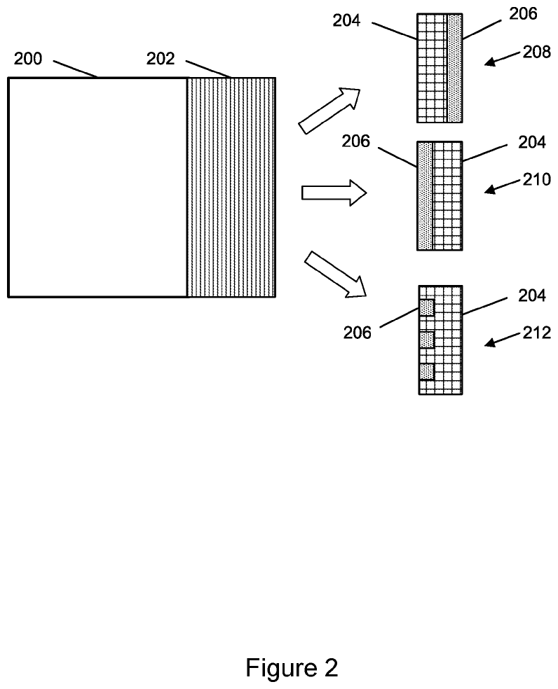

FIG. 2 illustrates a number of example arrangements of materials of a thermal management component coupled to one or more battery cells of a battery unit, in accordance with one or more example implementations. In the illustrative example of FIG. 2, a battery cell 200 is coupled to a thermal management component 202. In one or more examples, the battery cell 200 can correspond to a battery cell included in the battery unit 100, such as the first battery cell 102, described in relation to FIG. 1. The thermal management component 202 can comprise a number of arrangements with each arrangement including a heat transfer material 204 and a heat storage and release material 206.

In one or more examples, the thermal management component 202 can comprise a first arrangement 208 that includes the heat transfer material 204 being adjacent to the battery cell 200 and the heat storage with release material 206 being adjacent to the heat transfer material 204 and separated from the battery cell 200 by the heat transfer material 204. In one or more additional examples, the thermal management component 202 can comprise a second arrangement 210 that includes the heat storage and release material 206 being adjacent to the battery cell 200 with the heat transfer material 204 being adjacent to the heat storage and release material 206 and being separated from the battery cell 200 by the heat storage and release material 206. In one or more further examples, the thermal management component 202 can comprise a third arrangement 212 that includes the heat storage and release material 206 being disposed at least partially within the heat transfer material 204. In these scenarios, the heat transfer material 204 and the heat storage and release material 206 can be adjacent to the battery cell 200. In various examples, the third arrangement 212 of the thermal management component 202 can provide additional stability to the battery cell 200. In one or more illustrative examples, the with respect to the third arrangement 212, the heat storage and release material 206 can be disposed in divots or other pockets formed in the heat transfer material 204. In various examples, the heat storage and release materials 206 can be formulated as a paste or other spreadable material and spread onto the heat transfer material 204. In this way, the heat storage and release material 206 can be deposited into the divots or other pockets formed in the heat transfer material 204.

In various examples, the heat transfer material 204 can comprise one or more conductive materials. To illustrate, the heat transfer material 204 can comprise at least one of a carbon-containing material or one or more metallic materials. In one or more illustrative examples, the heat transfer material 204 can comprise carbon fibers. In one or more additional illustrative examples, the heat transfer material 204 can comprise at least one of copper, alloys of copper, aluminum, or alloys of aluminum. In various examples, the heat transfer material 204 can have a heat transfer rate of at least 125 watts/meter Kelvin (W/mK), at least 150 W/mK, at least 175 W/mK, at least 200 W/mK, or at least 250 W/mK in situations where the heat transfer material 204 has a tensile strength no greater than about 350 megapascals (MPa) and density from about 2.5 grams/cm³ to about 3 grams/cm³. In one or more further examples, the heat transfer material can have a heat transfer rate from about 15 W/mK to about 30 W/mK in instances where the heat transfer material 204 has a tensile strength of at least 500 MPa, at least 550 MPa, at least 600 MPa, at least 650 MPa, at least 700 MPa, or at least 750 MPa and a density from about 1.5 g/cm³ to about 2.5 g/cm³.

Additionally, the heat storage and release material 206 can comprise a phase change material. In one or more examples, the heat storage and release material 206 can comprise a salt. For example, the heat storage and release material 206 can be selected for the battery cell 200 based on an operating temperature of the battery cell 200 and/or a temperature of the heat storage and release material 206. In one or more illustrative examples, the heat storage and release material 206 can comprise at least one of sodium sulfide, sodium thiosulfide, or sodium acetate in scenarios where the operating temperature of the battery cell 200 is from about 45° C. to about 60° C. In one or more additional illustrative examples, the heat storage and release material 206 can comprise at least one of sodium hydroxide, magnesium nitrate, barium hydroxide, or mixtures of sodium hydroxide, magnesium nitrate, or barium hydroxide with lithium nitrate in instances where the operating temperature of the battery cell 200 is from about 60° C. to about 80° C. In one or more further illustrative examples, the heat storage and release material 206 can comprise at least one of ammonium alum or sodium sulfide in in situations where the operating temperature of the battery cell 200 is greater than about 80° C. and up to about 100° C. Ammonium alum can comprise a mixture of aluminum hydroxide, sulfuric acid, and ammonium sulfate.

In one or more examples, the heat storage and release material 206 can store heat in scenarios where the battery cell 200 is operating within a given operating temperature range that correspond to the heat storage and release material 206 and can being to release heat when the battery cell 200 operations at temperatures above the given operating temperature range. For example, in situations where the heat storage and release material 206 include at least one of sodium sulfide, sodium thiosulfide, or sodium acetate, the heat storage and release material 206 can store heat produced during operation of the battery cell 200 at temperatures from about 45° C. to about 60° C. and begin to release heat when the operating temperature exceed 60° C. In this way, the thermal management component 202 can provide a safety feature in that if the operation of a vehicle that includes the battery cell 200 experiences a situation that causes a rapid and relatively large transfer of energy from the battery cell 200 and causes the battery cell 200 to exceed an operating temperature range of the battery cell 200, the heat storage and release material 206 can operate as a valve to release the excess heat and minimize the risk of the battery cell 200 being damaged due to overheating.

Although not shown in the illustrative example of FIG. 1, in at least some examples, the battery cell 200 can include a heat transfer mechanism that can be coupled to an external source to provide energy, such as thermal energy into the battery cell 200 that can be stored by the heat storage and release material 206. In one or more examples, thermal energy can be transferred to the heat storage and release material 206 directly from the source via the heat transfer mechanism. Additionally, battery cell 200 can provide a transfer of energy from a source via induction using an electrical contact or a contactless mechanism to the heat storage and release material 206. In still further examples, the battery cell 200 can provide a transfer of energy from a source via radiation using an electrical contact or a contactless mechanism to the heat storage and release material 206. In one or more illustrative examples, the battery cell 200 can include one or more temperature sensors that can determine a temperature within one or more portions of the battery cell 200 and/or determine a temperature of the heat storage and release material 206 as part of a control mechanism for the supply of external energy to the heat storage and release material 206 and the charging and discharging of the battery cell 200.

A numbered non-limiting list of example aspects of the present subject matter is presented below.

Example 1. A battery unit, comprising: a plurality of battery cells in a stacked arrangement, wherein individual battery cells of the plurality of battery cells have discrete planar layers with dimensions x, y, and z and individual layers of the individual battery cells comprise a separator sublayer that includes one or more ceramic materials and a composite cathode-electrolyte sublayer including a solid electrolyte; wherein the battery cells are arranged such that the plurality of battery cells has a heat transfer hxy in the x and y dimensions of the planar layers and a heat transfer rate hz perpendicular to the planar layers; and wherein the ratio hxy/hz is greater than 2.

Example 2. The battery unit of example 1, further comprising a heat transfer component that includes one or more heat storage and release materials.

Example 3. The battery unit of example 2, wherein the heat transfer component includes one or more heat transfer materials.

Example 4. The battery unit of example 3, wherein one or more battery cells of the plurality of battery cells is in direct contact with the heat transfer component.

Example 5. The battery unit of example 3, wherein one or more battery cells is in direct contact with the one or more heat storage and release materials.

Example 6. The battery unit of example 3, wherein one or more battery cells of the plurality of battery cells is in direct contact with the one or more heat transfer materials.

Example 7. The battery unit of example 6, wherein the one or more heat storage and release materials are in direct contact with the one or more heat transfer materials.

Example 8. The battery unit of example 3, wherein one or more battery cells of the plurality of battery cells is in partial contact with the one or more heat transfer materials and in partial contact with the one or more heat storage and release materials.

Example 9. The battery unit of example 8, wherein the one or more heat transfer materials are embedded between a surface of a battery cell of the one or more battery cells and the one or more heat storage and release materials.

Example 10. The battery unit of any one of examples 1-9, wherein the ratio hxy/hz is at least 5.

Example 11. The battery unit of any one of examples 1-10, wherein the ratio between a height of the plurality of battery cells in the stacked arrangement, z, and the mean value of x and y is equal to the ratio of the heat transfer rate.

Example 12. The battery unit of any one of claims 1-11, wherein the planar layers of the battery cells have values of a dimension y that are no smaller than 0.5 times values of a dimension x.

Example 13. The battery unit of example 3, wherein the one or more heat storage and release materials comprise a phase change material.

Example 14. The battery unit of example 13, wherein the phase change material comprises a salt.

Example 15. The battery unit of example 14, wherein the salt is selected from: sodium sulfide, sodium thiosulfide, or sodium acetate for operating temperatures of the plurality of battery cells between 45 and 60 degrees Celsius, at least one of sodium hydroxide, magnesium nitrate, barium hydroxide, or lithium nitrate for operating temperatures of the plurality of battery cells between 60 and 80 degrees Celsius, or ammonium alum and sodium sulfide for operating temperatures of the plurality of battery cells up to 100 degrees Celsius.

Example 16. The battery unit of any one of claims 1-15, wherein the battery unit is connected to an electric powertrain of a vehicle.

Example 17. The battery unit of example 16, wherein the vehicle is an urban air mobility (UAM) vehicle.

Example 18. A battery unit, comprising: a plurality of stacked battery cells, wherein the battery cells have discrete layers with dimensions x, y, and z; and one or more heat transfer components with individual heat transfer components of the one or more heat transfer components coupled to one or more individual battery cells, the one or more heat transfer components comprising one or more heat transfer materials; wherein the plurality of battery cells are arranged such that the plurality of stacked battery cells has a heat transfer hxy in the x and y dimensions of the planar layers and a heat transfer rate hz perpendicular to the planar layers, wherein the ratio hxy/hz is greater than 2.

Example 19. The battery unit of example 18, wherein the one or more heat transfer components comprise one or more heat storage and release materials.

Example 20. The battery unit of example 19, wherein the one or more heat storage and release materials are embedded in the one or more heat transfer materials.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A battery unit, comprising:
a plurality of battery cells in a stacked arrangement, wherein individual battery cells of the plurality of battery cells have discrete planar layers with dimensions x, y, and z and individual layers of the individual battery cells comprise a separator sublayer that includes one or more ceramic materials and a composite cathode-electrolyte sublayer including a solid electrolyte;
wherein the plurality of battery cells are arranged such that the plurality of battery cells has a heat transfer hxy in the x dimension and the y dimension of the planar layers and a heat transfer rate hz perpendicular to the planar layers; and
wherein a ratio hxy/hz is greater than 2.

2. The battery unit of claim 1, further comprising a heat transfer component that includes one or more heat storage and release materials.

3. The battery unit of claim 2, wherein the heat transfer component includes one or more heat transfer materials.

4. The battery unit of claim 3, wherein one or more battery cells of the plurality of battery cells are in direct contact with the heat transfer component.

5. The battery unit of claim 4, wherein the one or more battery cells is in direct contact with the one or more heat storage and release materials.

6. The battery unit of claim 3, wherein one or more battery cells of the plurality of battery cells is in direct contact with the one or more heat transfer materials.

7. The battery unit of claim 6, wherein the one or more heat storage and release materials are in direct contact with the one or more heat transfer materials.

8. The battery unit of claim 3, wherein one or more battery cells of the plurality of battery cells is in partial contact with the one or more heat transfer materials and in partial contact with the one or more heat storage and release materials.

9. The battery unit of claim 8, wherein the one or more heat transfer materials are embedded between a surface of a battery cell of the one or more battery cells and the one or more heat transfer materials.

10. The battery unit of claim 1, wherein the ratio hxy/hz is at least 5.

11. The battery unit of claim 1, wherein a ratio between a height of the plurality of battery cells in the stacked arrangement, z, and a mean value of x and y is equal to the ratio hxy/hz of the heat transfer rate.

12. The battery unit of claim 1, wherein the planar layers of the individual battery cells have values of the y dimension that are no smaller than 0.5 times values of the x dimension.

13. The battery unit of claim 3, wherein the one or more heat storage and release materials comprises a phase change material.

14. The battery unit of claim 13, wherein the phase change material comprises a salt.

15. The battery unit of claim 14, wherein the salt is selected from:
sodium sulfide, sodium thiosulfide, or sodium acetate for operating temperatures of the plurality of battery cells between 45 and 60 degrees Celsius,
at least one of sodium hydroxide, magnesium nitrate, barium hydroxide, or lithium nitrate for operating temperatures of the plurality of battery cells between 60 and 80 degrees Celsius, or
ammonium alum and sodium sulfide for operating temperatures of the plurality of battery cells up to 100 degrees Celsius.

16. The battery unit of claim 1, wherein the battery unit is connected to an electric powertrain of a vehicle.

17. The battery unit of claim 16, wherein the vehicle is an urban air mobility (UAM) vehicle.

18. A battery unit, comprising:
a plurality of battery cells in a stacked arrangement, wherein the plurality of battery cells have discrete planar layers with dimensions x, y, and z; and
one or more heat transfer components with individual heat transfer components coupled to one or more individual battery cells, the one or more heat transfer components comprising one or more heat transfer materials;
wherein the plurality of battery cells are arranged such that the plurality of stacked battery cells has a heat transfer hxy in the x and y dimensions of the planar layers and a heat transfer rate hz perpendicular to the planar layers,
wherein a ratio hxy/hz is greater than 2.

19. The battery unit of claim 18, wherein the one or more heat transfer components comprise one or more heat storage and release materials.

20. The battery unit of claim 19, wherein the one or more heat storage and release materials are embedded in the one or more heat transfer materials.
